(19) United States
(12) Patent Application Publication
(10) Pub. No.: US 2026/0099017 A1
(43) Pub. Date: Apr. 9, 2026

(54) Stacked Ferrules for On-Board Optical Interconnects

(71) Applicant: 3M INNOVATIVE PROPERTIES COMPANY, St. Paul, MN (US)

(72) Inventors: David B. Stegall, St. Paul, MN (US); Jonathan L. Tolstedt, St. Paul, MN (US)

(21) Appl. No.: 19/114,889

(22) PCT Filed: Sep. 22, 2023
(86) PCT No.: PCT/IB2023/059409

§ 371 Date: Mar. 25, 2025

Related U.S. Application Data
(60) Provisional application No. 63/410,668, filed on Sep. 28, 2022.

(51) Int. Cl. G02B 6/42

(52) U.S. Cl. CPC G02B 6/4214; G02B 6/4292

(57) ABSTRACT

A stack of the optical ferrules, each of the optical ferrules including a top surface having attachment areas for optical waveguides, a light redirecting member, and a bottom surface having an exit window. When optical waveguides are attached to the attachment areas, central light rays emitted by the optical waveguides are redirected by the light redirecting member and exit the optical ferrule through the exit window. For each pair of adjacent stacked upper and lower optical ferrules, the exiting central light ray of the upper optical ferrule enters the lower optical ferrule through the top surface of the lower optical ferrule and exits the lower optical ferrule through the exit window of the lower optical ferrule. Each of the exiting central light rays of each of the optical ferrules exits the exit window of a lowermost optical ferrule at a different location.

### SUMMARY

In some aspects of the present description, a plurality of individual discrete optical ferrules is provided, the plurality of optical ferrules assembled along thickness directions of the optical ferrules to form a stack of the optical ferrules. Each of the optical ferrules includes a top surface and a bottom surface opposite the top surface. The top surface includes a plurality of attachment areas for receiving and permanently attaching to a plurality of corresponding optical waveguides, and a light redirecting member. The bottom surface of each of the optical ferrules includes an exit window. The top and bottom surfaces define the thickness direction of the optical ferrule therebetween, such that when the optical waveguides are received and permanently attached to the attachment areas, central light rays emitted by the optical waveguides are redirected by the light redirecting member and exit the optical ferrule through the exit window as exiting central light rays. For each pair of adjacent stacked upper and lower optical ferrules in the plurality of stacked optical ferrules, the exiting central light ray of the upper optical ferrule enters the lower optical ferrule through the top surface of the lower optical ferrule and exits the lower optical ferrule through the exit window of the lower optical ferrule. Each of the exiting central light rays of each of the optical ferrules in the plurality of optical ferrules exits the exit window of a lowermost optical ferrule at a different location of the exit window of the lowermost optical ferrule.

In some aspects of the present description, a plurality of optical ferrules is provided Each of the plurality of optical ferrules includes a light redirecting member and an exit window. The light redirecting member is configured to receive, along a first direction, one or more central light rays emitted from a corresponding one or more optical waveguides attached to the optical ferrule and redirect the one or more received central light rays along a different second direction as one or more redirected central light rays. The redirected central light rays exit the optical ferrule through the exit window of the optical ferrule as one or more exiting central light rays. Each of the one or more exiting central light rays of each of the optical ferrules passes through a different exit location of the exit window of a same optical ferrule in the plurality of the optical ferrules.

In some aspects of the present description, an optical stack is provided, the optical stack includes a plurality of optical ferrules assembled along thickness directions of the optical ferrules. Each of the optical ferrules is configured so that a plurality of central light rays emitted by a corresponding plurality of optical waveguides optically coupled to the optical ferrule enters the optical ferrule along a first direction and are bent by the optical ferrule so as to exit the optical stack through a same exit surface of the optical stack along a different second direction. The central light rays enter each of optical ferrules along the first direction and exit the optical stack through the exit surface of the optical stack after going through every of the other optical ferrules that may be disposed between the optical ferrule and the exit surface.

### BRIEF DESCRIPTION OF THE DRAWINGS

FIG. 1 is a perspective view of an optical stack including a plurality of individual optical ferrules in accordance with an embodiment of the present description;

FIGS. 2A-2C provide various exploded views of an optical stack, in accordance with an embodiment of the present description;

FIGS. 3A-3B illustrate how the individual optical ferrules in an optical stack may be offset relative to one another, in accordance with an embodiment of the present description; and

FIG. 4 shows how the individual optical ferrules in an optical stack may be offset relative to one another in a width dimension, in accordance with an embodiment of the present description;

FIGS. 5A and 5B show how the individual optical ferrules in an optical stack may be offset relative to one another in multiple dimensions, in accordance with an embodiment of the present description; and

FIG. 6 is an additional perspective view of an optical stack, in accordance with an embodiment of the present description.

### DETAILED DESCRIPTION

In the following description, reference is made to the accompanying drawings that form a part hereof and in which various embodiments are shown by way of illustration. The drawings are not necessarily to scale. It is to be understood that other embodiments are contemplated and may be made without departing from the scope or spirit of the present description. The following detailed description, therefore, is not to be taken in a limiting sense.

The integrated photonics industry, also known as silicon photonics, is experiencing rapid innovation that is following the paradigm pioneered by the micro-electronics industry. Microscopic optical circuitry will become intimately integrated with conventional silicon microchip circuitry for the purposes of improving data transfer within the microchip and ultimately off the microchip. As data communication bandwidths continue to increase over time, the number of input/output ports will be expected to scale up accordingly. Since the primary features providing the most valuable functionality are located within the interior of the chip, the input/output ports are most often found along the perimeter.

A major constraint for unlimited scaling up the number of ports is the diameter of the optical fiber that is the standard conduit for transporting data off the chip. Fiber diameters come in standard sizes, with cladding diameters such as 125 microns or 80 microns. Increasing the channel count on a chip by merely increasing the number of fibers in a linear array will eventually run out of room because the chips will not increase in size. Rather, the industry expects a reduction to chip size as the technology advances. There is a need in the industry for a method of increasing channels to the chip without violating the size constraints of the chip. In order to increase the number of input/output ports on a microchip that can be feasibly coupled to optical fibers, more than a single row of ports along the edge of the chip are proposed.

According to some aspects of the present description, a plurality of individual discrete optical ferrules is assembled along thickness directions (e.g., a z-axis of the optical stack) of the optical ferrules to form a stack of the optical ferrules. In some embodiments, the optical ferrules may be removably assembled (i.e., such that the optical ferrules may be disconnected from one another as needed). In some embodiments, the plurality of optical ferrules may include at least three individual discrete optical ferrules. In some embodiments, each of the optical ferrules may include a top surface and a bottom surface opposite the top surface, such that the top and bottom surface define the thickness direction therebetween. In some embodiments, the optical ferrules in the stack of optical ferrules may be bonded together, held in place in the stack by mechanical features (e.g., one or more alignment features or engagement features), clamped together, or assembled in any appropriate manner.

In some embodiments, the top surface may include a plurality of attachment areas for receiving and permanently attaching to a plurality of corresponding optical waveguides (e.g., optical fibers) and a light redirecting member. In some embodiments, the attachment areas of each of the optical ferrules may include a plurality of grooves extending along a length direction of the optical ferrule. In some embodiments, each of the grooves may be configured to receive and permanently attach to a corresponding optical waveguide in the plurality of the corresponding optical waveguides.

In some embodiments, the bottom surface may include an exit window. In some embodiments, when the optical waveguides are received and permanently attached to the attachment areas, central light rays are emitted by the optical waveguides and are redirected by the light redirecting member and exit the optical ferrule through the exit window as exiting central light rays. In some embodiments, the central light rays emitted by the optical waveguides may be redirected by the light redirecting members by an angle of at least 40 degrees, or at least 50 degrees, or at least 60 degrees, or at least 70 degrees, or at least 80 degrees. In some embodiments, the central light rays emitted by the optical waveguides are redirected by the light redirecting members by a redirection angle, wherein the redirection angles of the optical ferrules vary by less than about 10 degrees, or less than about 8 degrees, or less than about 6 degrees, or less than about 4 degrees, or less than about 3 degrees, or less than about 2 degrees, or less than about 1 degree (i.e., the redirection angles of the different optical ferrules may be such that the central light rays emitted by the optical ferrules may be substantially parallel).

In some embodiments, for each pair of adjacent stacked upper and lower optical ferrules in the plurality of stacked optical ferrules, the exiting central light ray of the upper optical ferrule enters the lower optical ferrule through the top surface of the lower optical ferrule and exits the lower optical ferrule through the exit window of the lower optical ferrule. In some embodiments, each of the exiting central light rays of each of the optical ferrules in the plurality of optical ferrules may exit the exit window of a lowermost optical ferrule at a different location of the exit window of the lowermost optical ferrule.

In some embodiments, the central light rays emitted by the optical waveguides may be incident on the light redirecting member of the optical ferrule along a substantially straight incident line, and the incident lines of each of the optical ferrules may be offset relative to each other along a common length direction (e.g., an x-axis) of the optical ferrules. In some embodiments, the central light rays emitted by the optical waveguides may be incident on the light redirecting member of the optical ferrule at corresponding spaced apart incident locations thereon, such that, in a plan view in the thickness directions of the optical ferrules, they form a two-dimensional array of the incident locations of the light redirecting members of the optical ferrules such that none of the incident locations in the array overlaps any of the other incident locations in the array.

In some embodiments, each of the optical ferrules may further include a pair of opposing side walls spaced apart along a width direction (e.g., a y-axis) of the optical ferrule, extending along a length direction (e.g., an x-axis) of the optical ferrule, and joining the top and bottom surfaces of the optical ferrule.

In some embodiments, each of the optical ferrules may further include an input member, such that when the optical waveguides are received and permanently attached to the attachment areas, the central light rays emitted by the optical waveguides enter the optical ferrule through the input member of the optical ferrule. In such embodiments, the entered central light rays may be incident on the light redirecting member along a first direction, and the light redirecting member may redirect the incident central light rays along a different second direction. In some embodiments, the redirected central light rays may exit the optical ferrule through the exit window of the optical ferrule as the exiting central light rays. In some such embodiments, for each of the optical ferrules, the incident and the redirected central light rays may make an angle of between about 30 and 150 degrees therebetween.

In some embodiments, the exit window of at least one of the optical ferrules may include an anti-reflection coating disposed thereon to reduce a reflection of an incident light having a wavelength of greater than about 500 nm, or greater than about 600 nm, or greater than about 700 nm, or greater than about 800 nm, or greater than about 900 nm, or greater than about 1000 nm by at least 1%, or by at least 2%, or by at least 3%.

According to some aspects of the present description, each of the optical ferrules in a plurality of optical ferrules includes a light redirecting member configured to receive, along a first direction, one or more central light rays emitted from a corresponding one or more optical waveguides attached to the optical ferrule and redirect the one or more received central light rays along a different second direction as one or more redirected central light rays. In some embodiments, the redirected central light rays exit the optical ferrule through an exit window of the optical ferrule as one or more exiting central light rays. In some embodiments, each of the one or more exiting central light rays of each of the optical ferrules passes through a different exit location of the exit window of a same optical ferrule in the plurality of the optical ferrules.

In some embodiments, the plurality of optical ferrules may be either permanently or removably assembled along thickness directions (e.g., along z-axes) of the optical ferrules to form a stack of the optical ferrules. In some such embodiments, the optical ferrules in the plurality of optical ferrules may be substantially identical, and the optical ferrules may be offset relative to each other along at least a common length direction (e.g., an x-axis) of the optical ferrules.

In some embodiments, an optical communication system may include plurality of optical ferrules, such as the pluralities of optical ferrules described herein, the plurality of optical ferrules disposed on a substrate. In some embodiments, the substrate may include a plurality of optical elements (e.g., an optical grating, a silicon photonics chip, a sensor, etc.). In some embodiments, each of the one or more exiting central light rays of each of the optical ferrules that passes through the different exit location of the exit window of the same optical ferrule optically may be coupled to a different optical element in the plurality of optical elements. In some such embodiments, at least one optical ferrule of the plurality of optical ferrules may be substantially identical to at least one other optical ferrule of the plurality of optical ferrules.

According to some aspects of the present description, an optical stack includes a plurality of optical ferrules assembled along thickness directions (e.g., z-axes) of the optical ferrules. In some embodiments, each of the optical ferrules may be configured so that a plurality of central light rays emitted by a corresponding plurality of optical waveguided (e.g., optical fibers) optically coupled to the optical ferrule enters the optical ferrule along a first direction (e.g., along an x-axis of the ferrules) and are bent by the optical ferrule so as to exit the optical stack through a same exit surface of the optical stack along a different second direction. In some embodiments, the central light rays entering each of optical ferrules along the first direction may exit the optical stack through the exit surface of the optical stack after going through every of the other optical ferrules that may be disposed between the optical ferrule and the exit surface. In some embodiments, the optical ferrules in the plurality of optical ferrules may be substantially identical. In some embodiments, at least one of the optical ferrules may be different from at least one other of the optical ferrules.

In some embodiments, the optical ferrules in each pair of adjacent optical ferrules in the plurality of optical ferrules may be offset relative to each other along both length (e.g., an x-axis) and width (e.g., an opposing y-axis) directions of the optical ferrules.

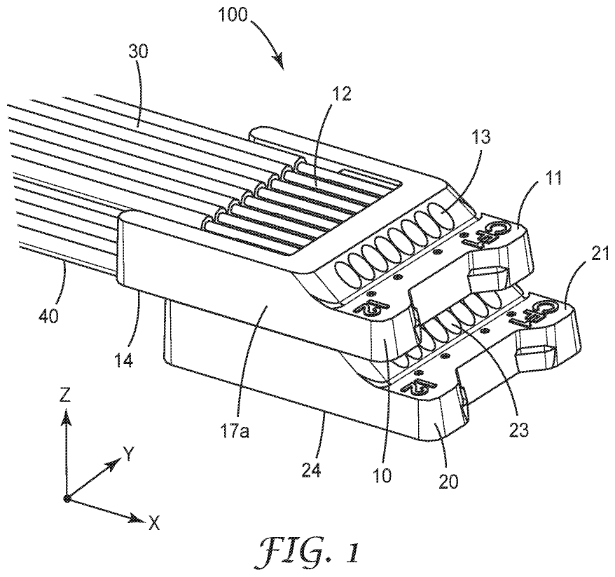

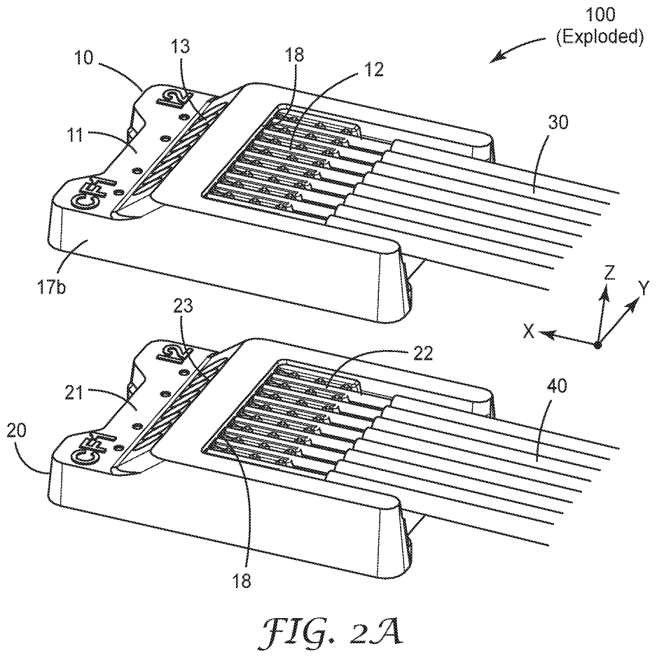

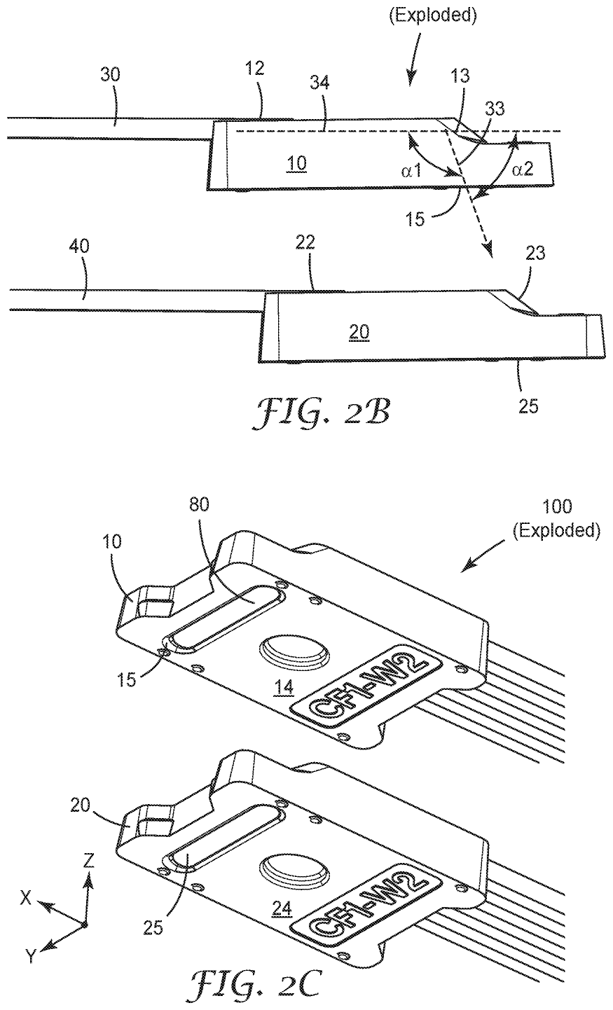

Turning now to the figures, FIG. 1 is a perspective view of an optical stack 100 including a plurality of individual optical ferrules, and FIGS. 2A-2C provide various exploded views of the optical stack 100 of FIG. 1. FIGS. 1 and 2A-2C should be reviewed together for the following discussion.

In some embodiments, an optical stack 100 may include a plurality of individual discrete optical ferrules 10, 20. In some embodiments, the optical ferrules 10, 20 may be removably or permanently assembled along thickness directions (e.g., the z-axis as shown in FIG. 1) of the optical ferrules 10, 20 to form optical stack 100.

In some embodiments, each of the optical ferrules may include a top surface 11, 21 and a bottom surface 14, 24 (see also FIG. 2C) opposite top surface 11, 21. In some embodiments, the top 11, 21 and bottom 14, 24 surfaces may define the thickness direction of the optical ferrule 10, 20 therebetween (corresponding to the z direction as defined in FIG. 1). In some embodiments, the top surface 11, 21 may include a plurality of attachment areas 12, 22 (see also FIG. 2A) for receiving and permanently attaching to a plurality of corresponding optical waveguides 30, 40. In some embodiments, top surface 11, 12 may also include a light redirecting member 13, 23.

In some embodiments, each of optical ferrules 10, 20 may further include a pair of opposing side walls 17a, 17b (see FIG. 1 and FIG. 2A) spaced apart along a width direction (e.g., the y-axis shown in FIGS. 1 and 2A) of the optical ferrule 10, 20, extending along a length direction (e.g., the x-axis) of the optical ferrule 10, 20, and joining the top 11, 12 and bottom surfaces 14, 24 of the optical ferrule 10, 20.

In some embodiments, bottom surface 14, 24 of optical ferrules 10, 20 may include an exit window 15, 25 (see FIG. 2C). In some embodiments, as shown in FIG. 2B, when the optical waveguides 30, 40 are received and permanently attached to attachment areas 12, 22, central light rays 34 emitted by optical waveguides 30, 40 are redirected by light redirecting member 13, 23 as redirected central light rays 33 and exit the optical ferrule 10, 20 through the exit window 15, 25.

In some embodiments, the exit window 15, 25 of at least one of the optical ferrules 10, 20 may include an anti-reflection coating 80 disposed thereon to reduce a reflection of an incident light having a wavelength of greater than about 500 nm, or greater than about 600 nm, or greater than about 700 nm, or greater than about 800 nm, or greater than about 900 nm, or greater than about 1000 nm by at least 1%, or by at least 2%, or by at least 3%.

In some embodiments, each of optical ferrules 10, 20 may further include an input member 18 (e.g., a surface adjacent the ends of optical fibers 30, 40, see FIG. 2A), such that when optical waveguides 30, 40 are received and permanently attached to attachment areas 12, 22, the central light rays 34 emitted by optical waveguides 30, 40 enter optical ferrule 10, 20 through input member 18.

In some embodiments, the incident central light rays 34 and the redirected central light rays 33 may make an angle a1 of between about 30 and 150 degrees therebetween. In some embodiments, the redirected central light rays 33 emitted by the optical waveguides 10, 20 are redirected by the light redirecting members by an angle a2 of at least 40 degrees, or at least 50 degrees, or at least 60 degrees, or at least 70 degrees, or at least 80 degrees.

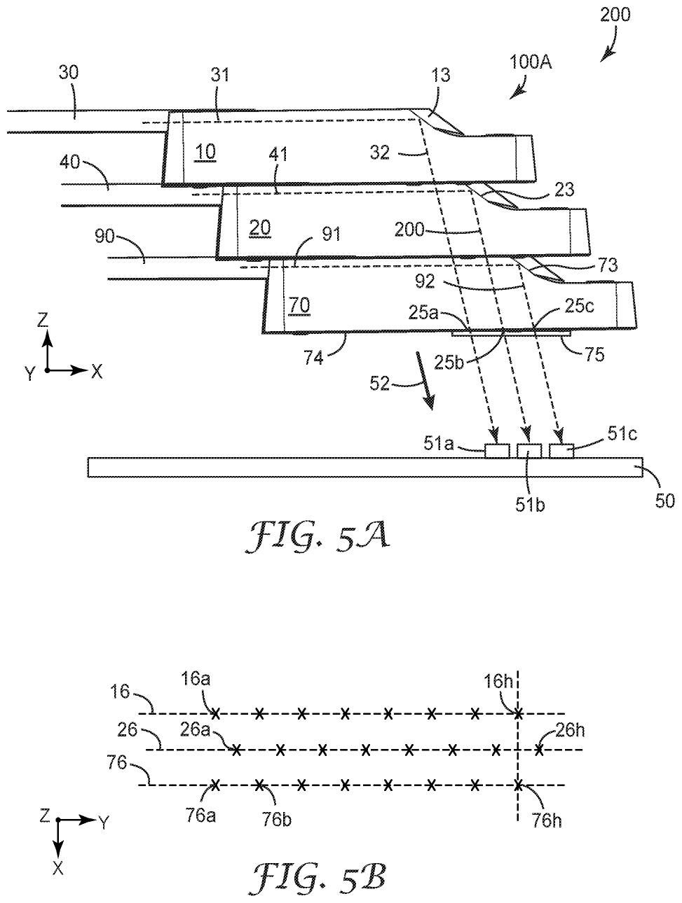

It should be noted that FIG. 2B only shows central light rays 34 for the top optical ferrule 10 for clarity. However, optical ferrule 20 may have similar central light rays emitted by optical waveguides 40 and redirected by light redirecting member 23, exiting through exit window 25. In addition, when optical stack 100 is fully assembled, redirected central light rays 33 exiting exit window 15 of optical ferrule 10 would pass through optical ferrule 20 and exit through an exit location on the bottom surface 24 on optical ferrule 20. This concept is shown in additional detail in at least FIG. 5 elsewhere herein. It should also be noted that, although the examples shown in FIGS. 1 and 2A-2C feature two optical ferrules (optical ferrule 10 and optical ferrule 20), embodiments according to the present description may include any appropriate number of optical ferrules, such as 3, or 4, or 5, or 6 optical ferrules. These examples are not intended to be limiting.

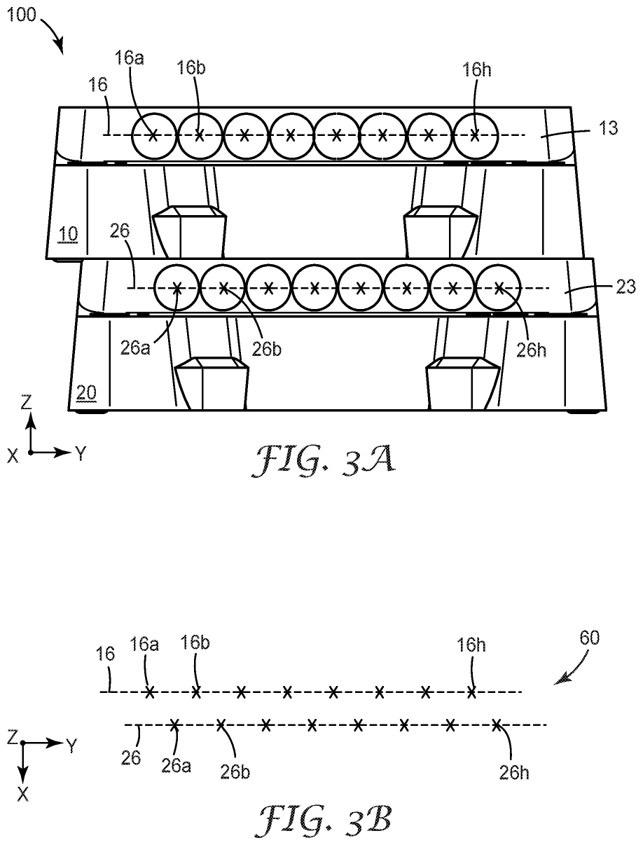

FIGS. 3A-3B illustrate how the individual optical ferrules in an optical stack, such as the optical stack 100 of previous figures, may be offset relative to one another. FIG. 3A is a front view of optical stack 100, and FIG. 3B is a top, plan view of optical stack 100 (Note: the bodies of optical ferrules 10 and 20 are left out of FIG. 3B for clarity).

In some embodiments, a plurality of individual discrete optical ferrules (e.g., 10, 20 of FIG. 3A) may create an optical stack 100. In some embodiments, when the optical waveguides (e.g., optical waveguides 30, 40 of FIG. 1) are received and permanently attached to the attachment areas (e.g., attachment areas 12, 22) of FIG. 1) of each of the optical ferrules 10, 20, the central light rays emitted by the optical waveguides 30, 40 may be incident on the light redirecting member 13, 23 of the corresponding optical ferrule 10, 20 along a substantially straight incident line (e.g., line 16 for optical ferrule 10, and line 26 for optical ferrule 20, along the y-axis shown in FIG. 3A), such that the incident lines 16, 26 of optical ferrules 10, 20 are offset relative to each other along a common length direction (e.g., offset along the x-axis as shown in FIG. 1) of optical ferrules 10, 20. That is, incident line 16 may be offset in the x-direction (i.e., either more into the page or more out of the page) relative to incident line 26. This offset is best seen in FIG. 3B, presenting a top, plan view of incident lines 16 and 26, showing incident lines 16 and 26 offset in the x-direction shown in FIG. 3B.

In some embodiments, the central light rays emitted by optical waveguides 30, 40 may be incident on light redirecting members 13, 23 of optical ferrules 10, 20 at corresponding spaced apart incident locations (e.g., incident locations 16a-16h for incident line 16, and incident locations 26a-26h of incident line 26). In some embodiments, in a plan view (e.g., the view of FIG. 3B) in the thickness directions of optical ferrules 10, 20, incident locations 16a-16h and 26a-26h may form a two-dimensional array 60, wherein none of incident locations 16a-16h, 26a-26h in array 60 overlaps any other incident locations in array 60. That is, in the embodiment captured in FIGS. 3A-3B, incident lines 16 and 26 (and, correspondingly, incident locations 16a-16h, 26a-26h) may be offset in both the x and y directions shown in FIGS. 3A and 3B. Also, due to the stacked nature of optical ferrules 10 and 20, incident lines 16 and 26 are also offset in the z or thickness direction.

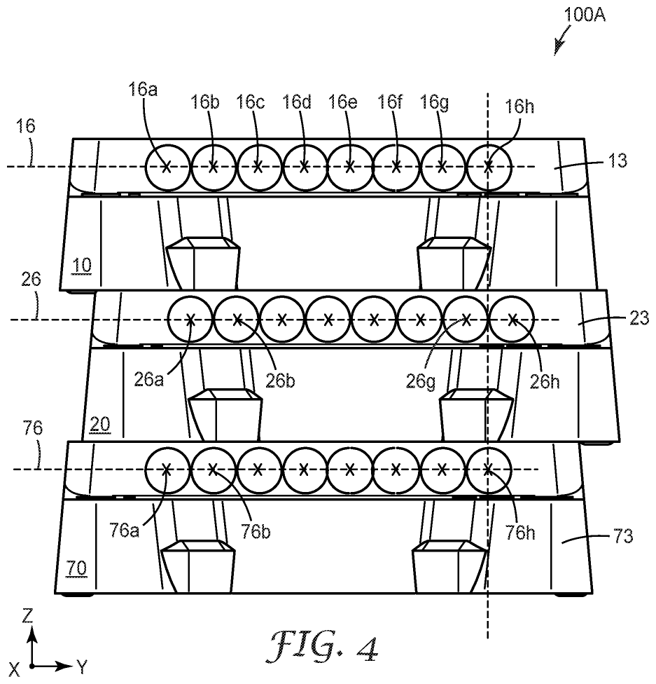

FIG. 4 is a front view of an embodiment of an optical stack 100a similar to the embodiment of optical stack 100 shown in FIG. 3A but featuring a third optical ferrule 70 in addition to optical ferrules 10 and 20. Similar to optical ferrules 10 and 20, optical ferrule 70 may, in some embodiments, feature an incident line 76 defined by incident locations 76a-76h. Each of incident locations 76a-76h represent points of incidence defining substantially straight incident line 76 of central light rays impinging on light redirecting member 73 of optical ferrule 70.

In some embodiments, the optical ferrules 10, 20, 70 in each pair of adjacent optical ferrules may be offset relative to each other along both length (e.g., the x-axis shown in FIG. 4) and width (e.g., the y-axis of FIG. 4) directions of the optical ferrules 10, 20, 70. For example, optical ferrule 10 may be offset from optical ferrule 20 such that incident locations 16a-16h of optical ferrule 10 are offset in both the x direction and y direction of FIG. 4 from incident locations 26a-26h of optical ferrule 20. Similarly, optical ferrule 20 may be offset from optical ferrule 70 such that incident locations 26a-26h of optical ferrule 20 are offset in both the x direction and y direction of FIG. 4 from incident locations 76a-76h of optical ferrule 70.

In some embodiments, at least one optical ferrule of the plurality of optical ferrules may be substantially identical to at least one other optical ferrule of the plurality of optical ferrules. In some embodiments, at least one optical ferrule of the plurality of optical ferrules may be different in structure from at least one other optical ferrule of the plurality of optical ferrules. In some embodiments, the optical ferrules of the plurality of optical ferrules may have an offset in a width direction (e.g., the y-direction of FIG. 4) that alternates for each optical ferrule in the optical stack 100 from a first offset value to a second offset value. For example, the offset in the width direction of optical ferrule 10 may be substantially similar to the offset in the width direction of optical ferrule 70 (i.e., both are offset by a same first offset value), while the offset in the width direction of the intervening optical ferrule 20 may be a different, second value. This is illustrated in FIG. 4 by the vertical dashed line drawn through incident point 16h of optical ferrule 10 and incident point 76h of optical ferrule 70, which conversely passes between incident points 26g and 26h of optical ferrule 20.

FIGS. 5A and 5B shows how the individual optical ferrules in an optical stack may be offset relative to one another in multiple dimensions. FIG. 5A is a side view of the optical stack 100A of FIG. 4, and FIG. 5B shows incident lines 16, 26, and 76 of FIG. 4 from a top, plan view. In optical stack 100A as shown in FIG. 5B, optical ferrules 10, 20, and 70 are shown offset from each other in the length direction of the optical ferrules (e.g., the x direction of FIG. 5A).

In some embodiments, when the optical waveguides 30, 40, 90 are received and permanently attached to the attachment areas of optical ferrules 10, 20, 70, central light rays 31, 41, 91 may be emitted by the corresponding optical waveguide and may be redirected by light redirecting member 13, 23, 73, and exit the corresponding optical ferrule through the corresponding exit window as exiting central light rays 32, 42, 92 in a second (redirected) direction 52.

In some embodiments, for each pair of adjacent stacked upper 10, 20 and lower 20, 70 optical ferrules in the plurality of stacked optical ferrules, the exiting central light ray 32, 42, 92 of the upper optical ferrule enters the lower optical ferrule through the top surface of the lower optical ferrule and exits the lower optical ferrule through the exit window of the lower optical ferrule. That is, the exiting central light ray of each optical ferrule may enter the optical ferrule immediately beneath it (if one exists). In one example, exiting central light ray 32 exits optical ferrule 10 and passes into and through optical ferrule 20 and then into and through optical ferrule 70, exiting the optical stack 100A from a bottom surface 74 of bottommost optical ferrule 70. In some embodiments, each of the exiting central light rays 32, 42, 92 of each of the optical ferrules 10, 20, 70 in the plurality of optical ferrules exits the exit window 75 of lowermost optical ferrule 70 at a different location 25a, 25b, 25c.

In some embodiments, an optical communication system 200 may include the optical stack 100A disposed on a substrate 50. In some embodiments, substrate 50 may include a plurality of optical elements 51a, 51b, 51c. In some embodiments, each of the one or more exiting central light rays 32, 42, 92 of each of optical ferrules 10, 20, 70 that passes through the different exit location 25a, 25b, 25c of the exit window 75 of the same optical ferrule 70 may be optically coupled to a different optical element 51a, 51b, 51c in the plurality of optical elements.

FIG. 5B shows the alignment of incident lines 16, 26, and 76 (and incident locations 16a-16h, 26a-26h, and 76a-76h, respectively) in one embodiment of the optical stack 100A in a top, plan view. In some embodiments, incident lines 16, 26, and 76 may be offset from each other in both the x direction (i.e., the length direction of the ferrules) and the y direction (i.e., the width direction). If each of the incident locations shown (shown by an “x” in FIG. 5B) represents a point of incidence on a corresponding light redirecting member of an optical ferrule, and assuming all redirected (exiting) central light rays (e.g., exiting central light rays 32, 42, and 92 of FIG. 5A) are substantially parallel, a corresponding pattern of optical elements 51 may be disposed on substrate 51 such that each optical element 51 receives an exiting light ray corresponding to the points of incidence shown in FIG. 5B. A two-dimensional array of optical elements 51 on substrate 50, corresponding to the two-dimensional array of incident points shown in FIG. 5B, would allow for a substrate with an increased number (a denser pattern) of input/output ports.

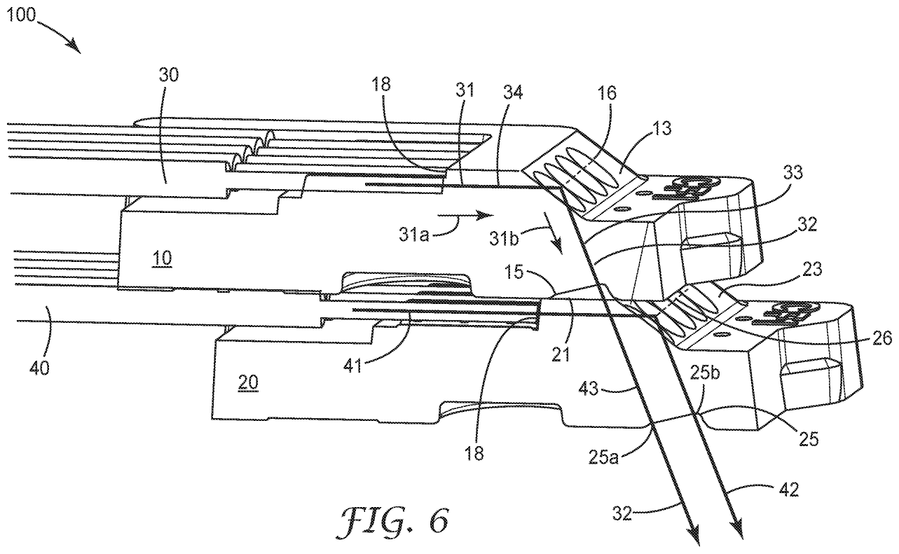

Finally, FIG. 6 is an additional view of an embodiment of an optical stack which provides an alternate perspective angle and additional detail and clarity on optical stack 100. Many of the elements shown in FIG. 6 have been discussed in figures and description elsewhere herein and should be assumed to have the same function as previously described herein unless specifically stated otherwise.

In some embodiments, optical stack 100 may include a plurality of optical ferrules, such as optical ferrule 10 and optical ferrule 20 (or, in other embodiments, any appropriate number of optical ferrules). Each optical ferrule 10, 20 may receive and be attached to a plurality of optical waveguides 30, 40 (e.g., a plurality of optical fibers). In some embodiments, each of the optical ferrules 10, 20 may further include an input member (e.g., an input surface) 18, such that when the optical waveguides 30, 40 are received and permanently attached to the attachment areas, the central light rays 31, 41 emitted by the optical waveguides 30, 40 enter the optical ferrule 10, 20 through the input member 18, such that the entered central light rays 34 incident on the light redirecting member 13, 23 along incident lines 16, 26 and along a first direction 31a, are redirected by light redirecting member 13, 23 along a different second direction 31b. In some embodiments, the redirected central light rays 33, 43 exit optical ferrule 10, 20 through exit window 15, 25 of the corresponding optical ferrule 10, 20 as exiting central light rays 32, 42. In some embodiments, each of the one or more exiting central light rays 32, 42 of each of the optical ferrules passes through a different exit location 25a, 25b of exit window 25 of the same optical ferrule 20. It should be noted that exiting central light rays 32 leave optical ferrule 10 via exit window 15 and enter optical ferrule 20 through top surface 21 of optical ferrule 20, before passing out of the optical stack 100 via exit window 25 of optical ferrule 20.

Terms such as “about” will be understood in the context in which they are used and described in the present description by one of ordinary skill in the art. If the use of “about” as applied to quantities expressing feature sizes, amounts, and physical properties is not otherwise clear to one of ordinary skill in the art in the context in which it is used and described in the present description, “about” will be understood to mean within 10 percent of the specified value. A quantity given as about a specified value can be precisely the specified value. For example, if it is not otherwise clear to one of ordinary skill in the art in the context in which it is used and described in the present description, a quantity having a value of about 1, means that the quantity has a value between 0.9 and 1.1, and that the value could be 1.

Terms such as “substantially” will be understood in the context in which they are used and described in the present description by one of ordinary skill in the art. If the use of “substantially equal” is not otherwise clear to one of ordinary skill in the art in the context in which it is used and described in the present description, “substantially equal” will mean about equal where about is as described above. If the use of “substantially parallel” is not otherwise clear to one of ordinary skill in the art in the context in which it is used and described in the present description, “substantially parallel” will mean within 30 degrees of parallel. Directions or surfaces described as substantially parallel to one another may, in some embodiments, be within 20 degrees, or within 10 degrees of parallel, or may be parallel or nominally parallel. If the use of “substantially aligned” is not otherwise clear to one of ordinary skill in the art in the context in which it is used and described in the present description, “substantially aligned” will mean aligned to within 20% of a width of the objects being aligned. Objects described as substantially aligned may, in some embodiments, be aligned to within 10% or to within 5% of a width of the objects being aligned.

All references, patents, and patent applications referenced in the foregoing are hereby incorporated herein by reference in their entirety in a consistent manner. In the event of inconsistencies or contradictions between portions of the incorporated references and this application, the information in the preceding description shall control.

Descriptions for elements in figures should be understood to apply equally to corresponding elements in other figures, unless indicated otherwise. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

1. A plurality of individual discrete optical ferrules assembled along thickness directions of the optical ferrules to form a stack of the optical ferrules, each of the optical ferrules comprising:
a top surface comprising a plurality of attachment areas for receiving and permanently attaching to a plurality of corresponding optical waveguides, and a light redirecting member; and
a bottom surface opposite the top surface and comprising an exit window, the top and bottom surfaces defining the thickness direction of the optical ferrule therebetween, such that when the optical waveguides are received and permanently attached to the attachment areas, central light rays emitted by the optical waveguides are redirected by the light redirecting member and exit the optical ferrule through the exit window as exiting central light rays,
wherein, for each pair of adjacent stacked upper and lower optical ferrules in the plurality of stacked optical ferrules, the exiting central light ray of the upper optical ferrule enters the lower optical ferrule through the top surface of the lower optical ferrule and exits the lower optical ferrule through the exit window of the lower optical ferrule, and wherein each of the exiting central light rays of each of the optical ferrules in the plurality of optical ferrules exits the exit window of a lowermost optical ferrule at a different location of the exit window of the lowermost optical ferrule.

2. The plurality of the individual discrete optical ferrules of claim 1, wherein the optical ferrules are removably assembled.

3. The plurality of the individual discrete optical ferrules of claim 1, wherein when the optical waveguides are received and permanently attached to the attachment areas of each of the optical ferrules, the central light rays emitted by the optical waveguides are incident on the light redirecting member of the optical ferrule along a substantially straight incident line, and wherein the incident lines of the optical ferrules are offset relative to each other along a common length direction of the optical ferrules.

4. The plurality of the individual discrete optical ferrules of claim 1, wherein when the optical waveguides are received and permanently attached to the attachment areas of each of the optical ferrules, the central light rays emitted by the optical waveguides are incident on the light redirecting member of the optical ferrule at corresponding spaced apart incident locations thereon, such that in a plan view in the thickness directions of the optical ferrules, form a two-dimensional array of the incident locations of the light redirecting members of the optical ferrules, wherein none of the incident locations in the array overlaps any of the other incident locations in the array.

5. The plurality of the individual discrete optical ferrules of claim 1 comprising at least three individual discrete optical ferrules.

6. The plurality of the individual discrete optical ferrules of claim 1, wherein the attachment areas of each of the optical ferrules is configured to receive and permanently attach to the corresponding optical waveguides, wherein the optical waveguides comprise optical fibers.

7. The plurality of the individual discrete optical ferrules of claim 1, wherein each of the optical ferrules further comprises a pair of opposing side walls spaced apart along a width direction of the optical ferrule, extending along a length direction of the optical ferrule, and joining the top and bottom surfaces of the optical ferrule.

8. The plurality of the individual discrete optical ferrules of claim 1, wherein the attachment areas of each of the optical ferrules comprises a plurality of grooves extending along a length direction of the optical ferrule, each of the grooves configured to receive and permanently attach to a corresponding optical waveguide in the plurality of the corresponding optical waveguides.

9. The plurality of the individual discrete optical ferrules of claim 1, wherein each of the optical ferrules further comprises an input member, such that when the optical waveguides are received and permanently attached to the attachment areas, the central light rays emitted by the optical waveguides enter the optical ferrule through the input member of the optical ferrule, the entered central light rays incident on the light redirecting member along a first direction, the light redirecting member redirecting the incident central light rays along a different second direction, the redirected central light rays exiting the optical ferrule through the exit window of the optical ferrule as the exiting central light rays.

10. The plurality of the individual discrete optical ferrules of claim 9, wherein for each the optical ferrules, the incident and the redirected central light rays make an angle of between about 30 and 150 degrees therebetween.

11. The plurality of the individual discrete optical ferrules of claim 1, wherein the central light rays emitted by the optical waveguides are redirected by the light redirecting members by an angle of at least 40 degrees.

12. The plurality of the individual discrete optical ferrules of claim 1, wherein the central light rays emitted by the optical waveguides are redirected by the light redirecting members by a redirection angle, and wherein the redirection angles of the optical ferrules vary by less than about 10 degrees.

13. (canceled)

14. A plurality of optical ferrules, each of the optical ferrules comprising a light redirecting member configured to receive, along a first direction, one or more central light rays emitted from a corresponding one or more optical waveguides attached to the optical ferrule and redirect the one or more received central light rays along a different second direction as one or more redirected central light rays, the redirected central light rays exiting the optical ferrule through an exit window of the optical ferrule as one or more exiting central light rays, each of the one or more exiting central light rays of each of the optical ferrules passing through a different exit location of the exit window of a same optical ferrule in the plurality of the optical ferrules.

15. The plurality of optical ferrules of claim 14, wherein the plurality of optical ferrules are removably assembled along thickness directions of the optical ferrules to form a stack of the optical ferrules.

16. The plurality of optical ferrules of claim 15, wherein the optical ferrules in the plurality of optical ferrules are substantially identical, and wherein the optical ferrules are offset relative to each other along at least a common length direction of the optical ferrules.

17. An optical communication system comprising the plurality of optical ferrules of claim 14 disposed on a substrate comprising a plurality of optical elements, each of the one or more exiting central light rays of each of the optical ferrules that passes through the different exit location of the exit window of the same optical ferrule optically coupled to a different optical element in the plurality of optical elements.

18. The optical communication system of claim 17, wherein at least one optical ferrule of the plurality of optical ferrules is substantially identical to at least one other optical ferrule of the plurality of optical ferrules.

19. An optical stack comprising a plurality of optical ferrules assembled along thickness directions of the optical ferrules, each of the optical ferrules configured so that a plurality of central light rays emitted by a corresponding plurality of optical waveguides optically coupled to the optical ferrule enters the optical ferrule along a first direction and are bent by the optical ferrule so as to exit the optical stack through a same exit surface of the optical stack along a different second direction, wherein the central light rays entering each of optical ferrules along the first direction exit the optical stack through the exit surface of the optical stack after going through every of the other optical ferrules that may be disposed between the optical ferrule and the exit surface.

20. The optical stack of claim 19, wherein the optical ferrules in the plurality of optical ferrules are substantially identical.

21. The optical stack of claim 19, wherein the optical ferrules in each pair of adjacent optical ferrules in the plurality of optical ferrules are offset relative to each other along both length and width directions of the optical ferrules.
